(19) United States
(12) Patent Application Publication
(10) Pub. No.: US 2023/0242451 A1
(43) Pub. Date: Aug. 3, 2023

(54) TOOLS AND METHODS FOR THEIR FORMATION AND USE

(71) Applicant: GENERAL ELECTRIC COMPANY, Schenectady, NY (US)

(72) Inventors: Paul E. Gray, North East, MD (US); Albert Jason Schaeffer, Newark, DE (US)

(21) Appl. No.: 17/591,688

(22) Filed: Feb. 3, 2022

(51) Int. Cl. C04B 35/52; C04B 41/50

(52) U.S. Cl. CPC C04B 35/522; C04B 41/5001; C04B 2235/74; C04B 2235/425

(57) ABSTRACT

A tool suitable for use in making a ceramic matrix composite part. The tool includes a graphite body. The graphite body can include multiple gas access holes. A porous surface of the graphite body can support the ceramic matrix composite part. The porous surface of the graphite body can be hermetically sealed.

### TECHNICAL FIELD

The disclosure generally relates to a tool used to form components, as such, a tool used in the manufacturing of ceramic matrix composite parts by chemical vapor infiltration.

### BACKGROUND

Chemical Vapor Infiltration (CVI) is a manufacturing approach to creating components having lightweight ceramic matrix composites with mechanical and thermal capabilities in various high temperature applications. Examples of components can include, but are not limited to, thruster nozzles for population systems, brake discs that can be used in aircraft landing systems, heat shielding or re-entry structures, or turbine engine hot-section components such as combustors, shrouds and vanes.

The CVI process begins when a porous carbon or ceramic fiber-based preform of the component is placed in a graphite tool, where the graphite tool contains gas access holes. The tool holding the component preform is then processed through a hydrocarbon gas-flowed vacuum furnace or CVI furnace that typically processes parts at 900 degrees Celsius (° C.)-1700° C. Within the CVI furnace, these hydrocarbon-containing gasses diffuse through the holes in the tooling and into the porous preform where they decompose on the fiber surfaces forming pyrolytic carbon. The CVI process and pyrolytic carbon formation rigidizes the preform, binding the fibers together, forming the component, and ensuring dimensional definition as well as post-process handling stability. The component is then removed or demolded from the tooling. During demolding, or separation of the tool from the component, the surface of the tool and/or the component can be impacted from the tool bonding to the preform causing preform delamination or surface irregularities.

### BRIEF DESCRIPTION OF THE DRAWINGS

A full and enabling disclosure, including the best mode thereof, directed to one of ordinary skill in the art, is set forth in the specification, which refers to the appended figures in which:

FIG. 1 is a side view of a tool assembly having a pair of tools used to make a ceramic matrix composite part, with the ceramic matrix composite part being sandwiched between the pair of tools, in accordance with an exemplary embodiment of the present disclosure.

FIG. 2 is a schematic perspective view of one of the tools of FIG. 1 in accordance with an exemplary embodiment of the present disclosure.

FIG. 3 is a cross section of the portion of the tool of FIG. 2 in accordance with an exemplary embodiment of the present disclosure.

FIG. 4 is a method for of forming a tool suitable for making a composite part formed at least in part by chemical vapor infiltration in accordance with an exemplary embodiment of the present disclosure.

FIG. 5 a variation of the method FIG. 4 in accordance with an exemplary embodiment of the present disclosure.

FIG. 6 is a method of using a tool for manufacturing a ceramic matrix composite part in accordance with an exemplary embodiment of the present disclosure.

### DETAILED DESCRIPTION

Traditionally, a tool which secures a preform during a CVI process can be coated prior to use. The process of coating the tool can include applying a seal coating and a release coating or release layer to one or more surfaces of the tool.

CVI tools may comprise various grades of graphite that contain from 5-20 percent open porosity. At least a portion of the open porosity or surface pores can be infiltrated with the gasses used in the CVI process. If the porous graphite tool is not sealed, during the CVI process the preform would likely bond to the porous graphite tool at the surface pores. The coating, which includes a seal coating and a release coating, can mitigate the porous surface of the graphite tool from bonding to the CMC preform thus preventing later separation of the preform from the tooling after CVI processing.

To seal the porous graphite tool, the porous graphite tool is processed separately first through a CVI furnace between approximately 900° C. to 1700° C. Gaseous species are absorbed into and onto the surface of the tool forming a deposition layer or seal coating on the tool. The deposition layer or seal coating is designed to fill the surface pores. That is, after being processed through the CVI furnace, the surface of the tool, including the surface pores, is hermetically sealed by the deposition layer or seal coating.

Traditionally, after the deposition layer or seal coating is formed, an additional release coating such as phenolic resin can be applied over at least a portion of the seal coating. The release coating is applied as a thin layer to the portion of the tool that will contact the preform or component. The purpose of the release coating is to form an additional glassy carbon layer which will poorly bond with any subsequent carbon or other compounds deposited by later CVI processes aiding the demolding of the preform from the tooling.

The release coating precursor for the phenolic resin is typically applied as a liquid then cured in a circulating air oven typically operating at temperatures at or between 120° C. and 250° C. Once cooled, the tool can receive a preform. The preform can be a porous material, such as a woven or braided fiber laminate, on which the subsequent CVI process deposits solid material from a gaseous precursor directly onto the internal structure of the preform. The solid material deposited to the internal structure of the preform provides rigidity. This CVI process of rigidizing the perform is performed in a CVI furnace at approximately 900° C.-1700° C. Additionally, as the preform and tooling are heated to the furnace operating temperature to perform the CVI process of rigidizing the perform, the release coating (e.g., phenolic resin) decomposes, forming a glassy carbon layer where the tool contacts the preform.

The glassy carbon boundary layer which forms from the pyrolysis of the phenolic release coating reduces the amount of contact area between the preform and graphite tooling surface as well as acting like a weak interface to reduce bonding of the preform to the tool. This additional glassy carbon layer acts to reduce surface defects on the tool and preform during the demolding process.

The now-rigid preform (without the tooling) is then placed back in the CVI furnace to finish densifying the component.

Processing preform tools through the CVI furnace to seal surface porosity is an expensive and time-consuming process. The seal coating obtained through CVI often increases component cost by as much as 30 percent. The seal coating requires 1-2 weeks to complete, which is a significant portion of the total production time of the component.

Aspects of the disclosure described herein are generally directed to a tool that is suitable for use in making a ceramic matrix composite part or a method of forming a tool suitable for use in making a composite part using the CVI process. The tool, as described herein, includes a coating applied to the tool that seals the tool without the use of the CVI furnace. That is, the tool, as described herein, receives a coating or coatings which eliminate the need for an additional dedicated CVI tool coating process. The coating or coatings described herein are capable of both effectively sealing the tool surfaces and providing a weak glassy carbon interface to allow ease of preform demolding from the tool. Further, the coatings or coatings can be applied using commonly-used painting procedures and cured in air-circulating ovens at temperatures at or between 60° C. and 250° C. It is contemplated that the coatings or coatings can be cured in air-circulating ovens at temperatures at or between 80° C. and 200° C.

For purposes of illustration, the present disclosure will be described with respect to a tool to be used in a CVI Silicon Carbide (SiC) infiltration. However, other CVI gasses and processes are contemplated and can include, but are not limited to any one or more of carbon (C), silicon nitride (Si₃N₄), boron nitride (BN), boron carbide (B₄C), or zirconium carbide (ZrC) infiltration.

Reference will now be made in detail to a tool assembly, illustrated in the accompanying drawings. The detailed description uses numerical and letter designations to refer to features in the drawings. Like or similar designations in the drawings and description have been used to refer to like or similar parts of the disclosure.

As used herein, the terms “first”, “second”, and “third” may be used interchangeably to distinguish one component from another and are not intended to signify location or importance of the individual components.

The term “fluid” may be a gas or a liquid. The term “fluid communication” means that a fluid is capable of making the connection between the areas specified.

The singular forms “a”, “an”, and “the” include plural references unless the context clearly dictates otherwise. Furthermore, as used herein, the term “set” or a “set” of elements can be any number of elements, including only one.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are used only for identification purposes to aid the reader's understanding of the present disclosure, and should not be construed as limiting, particularly as to the position, orientation, or use of aspects of the disclosure described herein. Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to one another. The exemplary drawings are for purposes of illustration only and the dimensions, positions, order and relative sizes reflected in the drawings attached hereto can vary.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, “generally”, and “substantially,” are not to be limited to the precise value specified. In at least some instances, the approximating language may correspond to the precision of an instrument for measuring the value, or the precision of the methods or machines for constructing or manufacturing the components and/or systems. In at least some instances, the approximating language may correspond to the precision of an instrument for measuring the value, or the precision of the methods or machines for constructing or manufacturing the components and/or systems. For example, the approximating language may refer to being within a 1, 2, 4, 5, 10, 15, or 20 percent margin in either individual values, range(s) of values and/or endpoints defining range(s) of values. Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

The term “open porosity” is commonly reduced to “porosity” and refers to the ratio of the fluid volume occupied by the continuous fluid phase to the total volume of porous material. That is open porosity can be reported as a percentage. The term “surface porosity” can be the ratio of the area of the pores at the surface to the total area of the surface. Similarly, this can also be reported as a percentage.

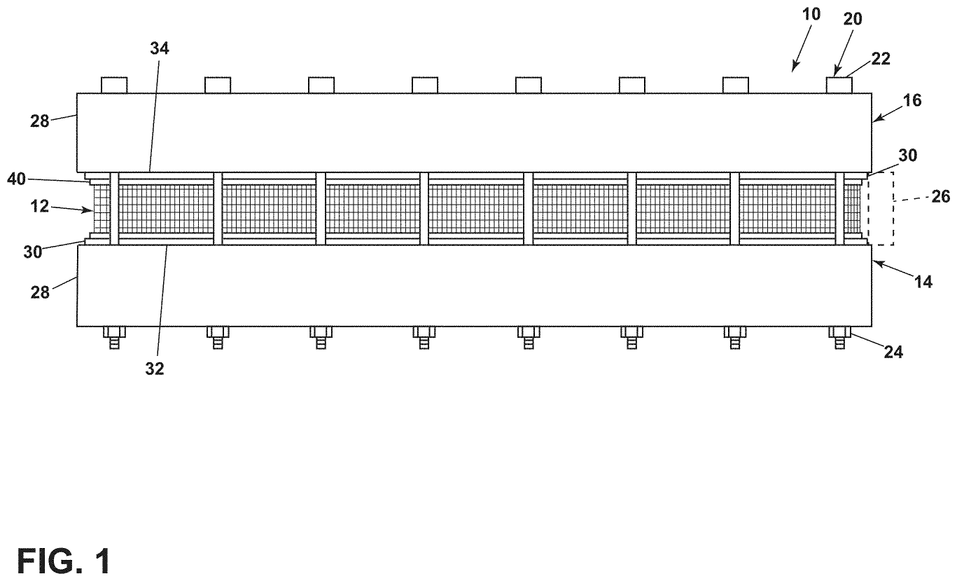

FIG. 1 is a schematic view of a tool assembly 10 suitable for use in making a ceramic matrix composite part 12. While illustrated as a rectangular prism, it is contemplated that the tool assembly 10 can have different height, length, and depth dimensions. It is also contemplated that the tool can be two or more pieces. The surface of one or more portions of one or more pieces of the tool can be contoured. That is, one or more surfaces of the tool can be concave or convex and include any number of recess or protrusions.

The tool assembly 10 is illustrated, by way of non-limiting example, as a first tool 14 and a second tool 16 that can sandwich the ceramic matrix composite part 12. While illustrated as having a pair of tools (the first tool 14 and the second tool 16), it is contemplated that the tool assembly 10 can include any number of tools, including one. The ceramic matrix composite part 12, as illustrated, can be a fibrous CMC preform prior to CVI processing. It is also contemplated that the ceramic matrix composite part 12 can illustrate a CMC part still mounted in the tool assembly 10 post CVI processing.

A plurality of fasteners 20 can be used to secure the first tool 14 and the second tool 16, where the ceramic matrix composite part 12 can be located between the first tool 14 and the second tool 16. That is, the tool assembly 10 can encompass or receive the ceramic matrix composite part 12. While illustrated as bolts 22 secured with nuts 24, any known mechanical fastener can be used. Non-limiting examples can include a quick release or set screw. Optionally, a spacer 26 can be placed between the first tool 14 and the second tool 16. While the spacer 26 is illustrated as a single spacer, any number of spacers are contemplated. It is also contemplated that the spacer 26 can circumscribe a portion of at least one of the plurality of fasteners 20.

The tool assembly 10, illustrated as the first tool 14 and second tool 16, includes a graphite body 28 and a coating. The coating, by way of non-limiting example, is illustrated as a seal coating, a base coat, or a first coating 30. The first coating 30 can cover one or more portions of the graphite body 28. That is, a first inner surface 32 of the first tool 14 and a second inner surface 34 of the second tool 16 can include the first coating 30. The first coating 30 is located on the surface of the graphite body 28 confronting the ceramic matrix composite part 12.

Optionally, the coating can include a release coating or a second coating 40 that can cover one or more portions of the first coating 30. The second coating 40 can be located between the first coating 30 and the ceramic matrix composite part 12. That is, the second coating 40 can be adjacent to or in contact with one or more portions of the ceramic matrix composite part 12 when the tool assembly 10 and the ceramic matrix composite part 12 are assembled and secured using the plurality of fasteners 20, as shown in FIG. 1. While illustrated as proportionately larger, for ease of understanding, the thickness of the first coating 30 or the thickness of the first coating 30 and the second coating 40 combined can be equal to or between 10 micrometers (0.0003 inches) and 200 micrometers (0.008 inches). It is contemplated that the thickness of the first coating 30 or the thickness of the second coating 40 can be equal to or between 10 micrometers (0.0003 inches) and 127 micrometers (0.005 inches). It is further contemplated that the thickness of the first coating 30 or the thickness of the second coating 40 can be equal to or between 15 micrometers (0.0006 inches) and 77 micrometers (0.003 inches). While shown as uniform, the thickness of the first coating 30 or the second coating 40 can vary from one portion to another.

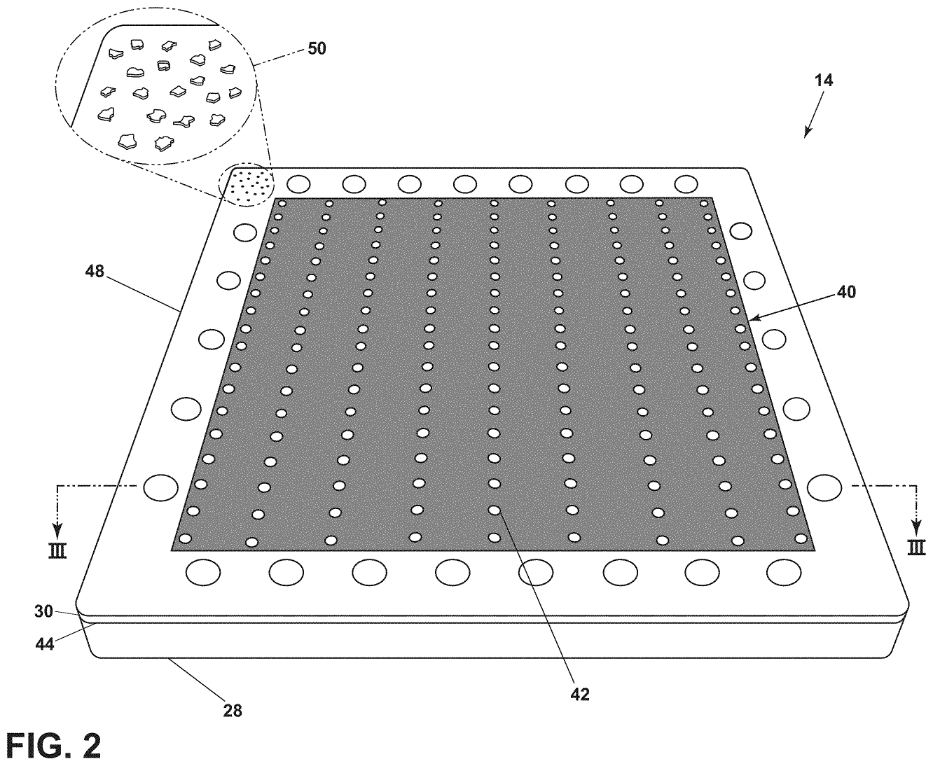

FIG. 2 is a schematic perspective view of a portion of the tool assembly 10, further illustrating the first tool 14 of the tool assembly 10. The graphite body 28 of the first tool 14 can include multiple gas access holes 42 and defining a porous surface 44. The porous surface 44 can support or confront the ceramic matrix composite part 12 when the tool assembly 10 is assembled (see FIG. 1).

A thermosetting, carbon-yielding resin can be applied to the porous surface 44 to form the first coating 30. Optionally, the first coating 30 can include multiple layers of the heat-cured, carbon-yielding resin. The heat-cured, carbon-yielding resin seals the porous surface 44 of the graphite body 28. Once cured and pyrolyzed, the carbon-yielding resin hermetically seals the porous surface 44 of the graphite body 28. The resin or the char from the pyrolyzed resin used to form the first coating 30 is non-reactive to CVI gasses that will be used to form the ceramic matrix composite part 12. The CVI gasses can include, but are not limited to any one or more of silicon carbide (SiC), carbon (C), silicon nitride (Si₃N₄), boron nitride (BN), boron carbide (B₄C), or zirconium carbide (ZrC). It is contemplated that the first coating 30 can be a resin that does not contain a significant amount (less than 0.1% of the total mass of the first coating 30) or is otherwise free of alkali or other transitional metals such as, but not limited to, sodium (Na), calcium (Ca), or iron (Fe). It is contemplated that the first coating 30 can be a resin that can be catalyzed and cross-linked at temperatures at or between 80° C. and 250° C. It is further contemplated that the first coating 30 can be a resin that can be catalyzed and cross-linked at temperatures at or between 80° C. and 200° C. The carbon-yielding resin can be any resin having a char yield in excess of 30 percent by weight. For example, the carbon-yielding resin can be, but is not limited to, one or more thermosetting furan-based resin or neat resin that can be a furan-based polymer. That is, any one of or combination of novolacs, Quacorr, pitch-based resins, pitch-based resin blends, furfuryl alcohol and resin blends or resin blends based upon 2-furaldehyde are considered.

Additionally, or alternatively, the carbon-yielding resin can be a phenolic resin or other carbon-yielding resins derived from such precursors as pitch, blends of pitch and furfuryl alcohol or combinations of 2-furaldehyde and resorcinol all containing a thermally-activated catalyst to initiate polymerization.

The first coating 30 can fill recesses or impregnate the porous surface 44 between the multiple gas access holes 42 to smooth and seal the porous surface 44 and define a first surface 48. That is, the graphite body 28, prior to use as a tool, receives the first coating 30. The first coating 30 is cured in a lower temperature furnace to create a hermetic vitreous carbon precursor surface that conceals the surface pores of the graphite body 28. The lower temperature furnace can be an air-circulated oven that operates at temperatures at or between 80° C. and 250° C. to cure the first coating 30. It is contemplated that the lower temperature furnace can be an air-circulated oven that operates at temperatures at or between 80° C. and 200° C. to cure the first coating 30. The first coating 30, when cured, can shrink generally normal to the porous surface 44. When further processed by pyrolysis, a vitreous or glassy carbon layer of the first coating 30 forms at the first surface 48. That is, the glassy carbon layer can define the first surface 48. The first coating 30 can be pyrolyzed in an inert-atmosphere retort furnace at or between approximately 500° C. and 600° C.

Optionally, filler particles 50 can also be included in the resin that forms the first coating 30 or the second coating 40. The resin to filler particles 50 volume ratio can be equal to or between 2.5:1 and 7:1. For example, the resin to filler particles 50 volume ratio can be 3.5:1 or 4:1.

The filler particles 50 can have widely varying densities, as long as the resin to filler particles 50 volume ratio is equal to or between 2.5:1 and 7:1. That is, filler particles with different densities can result in a similar coating microstructures as long as the volume ratio of resin to filler particles 50 is equal to or between 2.5:1 and 7:1.

Additionally, or alternatively, the resin to filler particles 50 mass ratio can be equal to or between 1.5:1 and 4:1. For example, the resin to filler particles 50 mass ratio can be 2.5:1 or 2:1.

It is contemplated that the filler particles 50 are non-reactive to CVI gasses used to form the ceramic matrix composite part 12. The filler particles 50 can be, but are not limited to graphite flakes or powder, carbon flakes or powder, nitride flakes or powder, or carbide flakes or powder, however any material or combinations of material that are non-reactive to the CVI gasses or includes a low sulfur content are contemplated. A low sulfur content can be defined as anything that is less than 0.1% sulfur. That is, the sulfur content of the first coating 30 is 0.1% of the total mass of the first coating 30 or less. The filler particles 50 can be free of or otherwise not include alkali or other transitional metals such as, but not limited to, sodium (Na), calcium (Ca), or iron (Fe).

The filler particles 50 can include a variety of sizes of particles, where a particle diameter measured across the largest portion of the particle equal to or between 0.1 micrometers and 53 micrometers (−270 mesh). By way of non-limiting example, 44 micrometer (−325 mesh) graphite flake can be the filler particle 50.

Optionally, the second coating 40 can be applied to one or more portions of the first coating 30. The second coating 40 can be applied to the vitreous or glassy carbon layer of the first coating 30 formed at the first surface 48. The second coating 40 can be, but is not limited to, a thermosetting furan-based resin or neat resin. It is contemplated that the second coating 40 and the first coating 30 can be the same resin. It is further contemplated that the first coating 30 can include thermosetting furan-based resin having the filler particles 50 and the second coating 40 includes a neat resin. Alternatively, the second coating 40 can include filler particles 50.

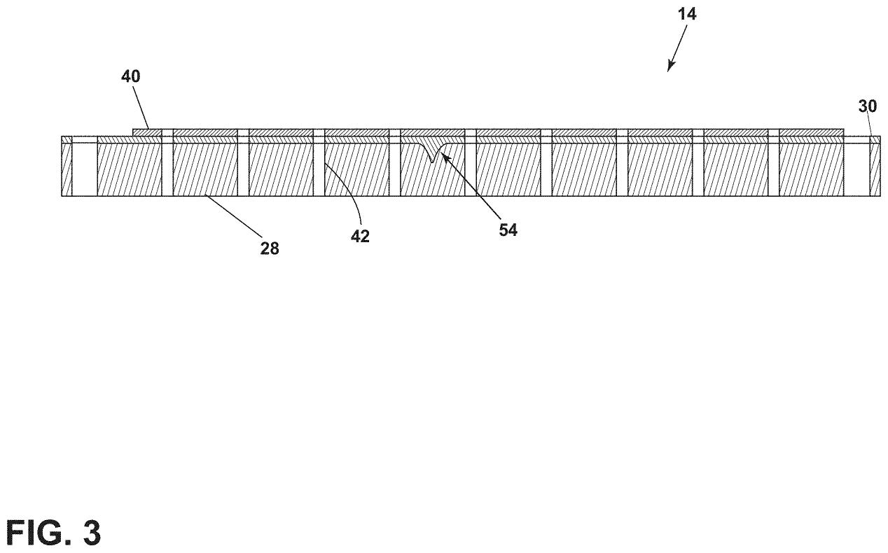

FIG. 3 is a cross section of the first tool 14 of the tool assembly 10, further illustrating the graphite body 28 and the first coating 30. The first coating 30 can fill or impregnates a recess, crack, or surface pore 54 of the graphite body 28.

The multiple gas access holes 42 are not blocked or impeded by the first coating 30 or the second coating 40. That is, the multiple gas access holes 42 pass through the first coating 30 and the second coating 40.

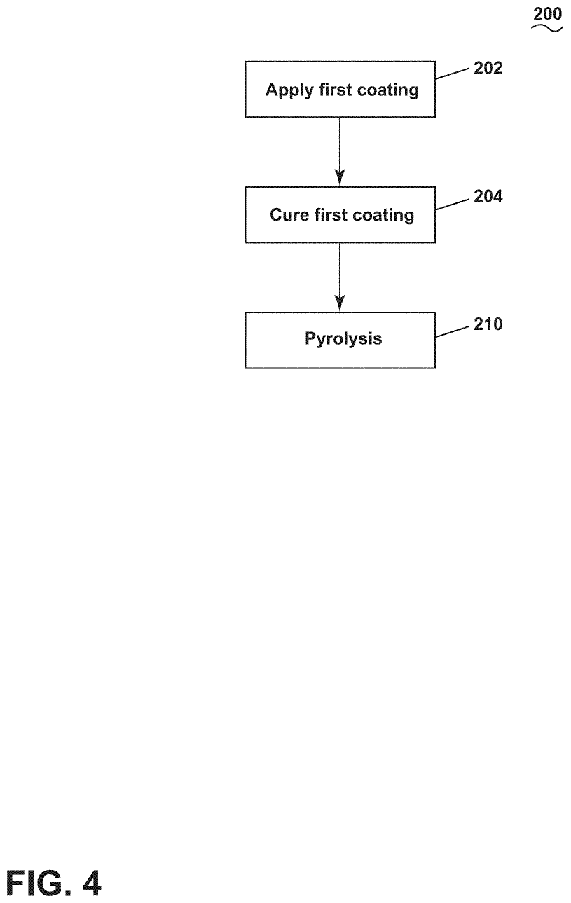

FIG. 4 illustrates a method 200 of forming a tool suitable for use in making a composite part in a chemical vapor infiltration process. At 202 the first coating of carbon-yielding resin is applied onto the porous surface 44 of a graphite body 28 of the tool assembly 10. That is, the first coating 30 is applied to the first inner surface 32 of one or more portions of the tool assembly 10. The first coating 30 can be a neat resin or a neat resin mixture. As used herein, the term “neat resin” is a resin that contains the main identified polymers, whereas the term “neat resin mixture” is a resin mixture of the main identified polymers and at least one other solution.

The first coating 30 can be a neat resin or a neat resin mixture, where the neat resin mixture can have a ratio of resin to solvent equal to or between 1:1 and 4:1 by volume. Additionally, or alternatively, the first coating 30 can be a neat resin mixture ranging from a 2:1 ratio of neat resin to solvent to 4:1 by mass. The solvent can be, but is not limited to, acetone. It is contemplated that the solvent can be one or more solvents and that the solvent can depend on the polymer precursor of the resin used in the first coating 30. The solvent can also depend of the solubility of the polymer precursor. Optionally, 1% or less of the weight of the neat resin mixture can be an organic catalyst. The organic catalyst can be, but is not limited to, dicumyl peroxide.

The first coating 30 can include the filler particles 50, combined, for example, in an approximately 4:1 volume ratio of the neat resin or the neat resin mixture to the filler particles 50. Additionally, or alternatively, the mass ratio of neat resin or neat resin mixture to filler particles 50 can be approximate 2.5:1. The first coating 30 can fill internal pores or the surface pores 54 of the graphite body 28.

At 204, the carbon-yielding resin or first coating 30 is cured during a first curing with heat at a temperature not greater than 250° C. The tool assembly 10 with the first coating 30 can be cured in a low temperate furnace operating between approximately 80° C. and 200° C.

At 210, the first coating 30 of the carbon-yielding neat resin, neat resin mixture, or resin mixture with filler particles 50 is pyrolyzed in an inert atmosphere pyrolysis furnace to create a vitreous or glassy carbon layer.

The first coating 30 can be pyrolyzed in an inert-atmosphere retort furnace at or between approximately 500° C. and 600° C.

Microcracks in the first coating 30 can be a result of the pyrolysis of the first coating 30. Microscopy reveals that the first coating 30, after pyrolysis at 210, has a significantly smoother surface when compared to the traditional CVI SiC coatings.

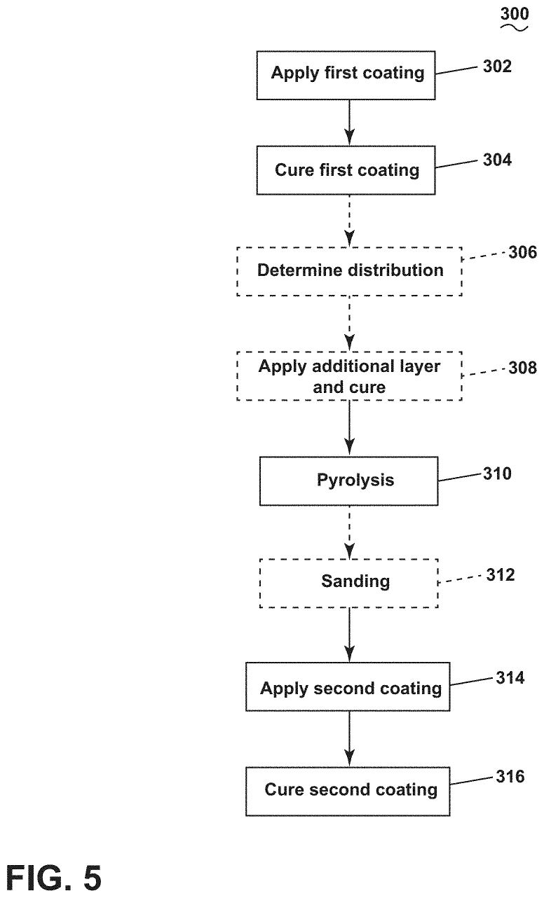

FIG. 5 illustrates a method 300 of forming a tool suitable for use in making a composite part in a chemical vapor infiltration process. The method 300 is a variation of the method 200.

At 302, similar to 202, the first coating 30 of carbon-yielding resin is applied onto the porous surface 44 of a graphite body 28 of the tool assembly 10. The carbon-yielding resin can be the neat resin, the neat resin mixture, or the resin mixture with filler particles 50.

When using resin without filler particles 50 (so-called neat resin), the porosity of the porous surface 44 holds the resin at the porous surface 44 allowing it to be thermally cured which can increase the hermeticity of the tool assembly 10 to CVI gasses.

When using resin with filler particles 50, the porosity of the tool assembly 10 at the porous surface 44 can cause the filler particles 50 in the first coating 30 to be filtered out during application and drying, forming a continuous particulate layer on the tool assembly 10. Capillary attraction between the filler particles 50 and the resin causes resin to be retained within the particulate layer increasing its' hermeticity to later penetration by the CVI process gasses.

Optionally, the first coating 30 can be more than one layers of the neat resin, neat resin mixture, or resin mixture with filler particles 50. That is, after the first curing, at 306, the distribution of the first layer of the neat resin, neat resin mixture, or resin mixture with filler particles 50 is determined. Based on the determination, at 308, another layer of the neat resin, the neat resin mixture, or the resin mixture with filler particles 50 can be applied to the tool assembly 10. The next layer is then cured by conducting a second curing. The determination at 306 and additional of layers and subsequent curing at 308 can be repeated until the desired first coating 30 is obtained. That is, the application and curing process can be repeated until the first coating 30 is visible and uniformly distributed across the porous surface 44, indicating the surface pores 54 have been sufficiently filled.

At 310, similar to 210, the first coating 30 of one or more layers of the carbon-yielding neat resin, the neat resin mixture, or the resin mixture with filler particles 50 is pyrolyzed in a pyrolysis furnace to create a vitreous or glassy carbon layer. The pyrolysis furnace can operate at temperatures at or between approximately 500° C. and 600° C.

Optionally, at 312, the glassy carbon layer at the first surface 48 of the first coating 30 can be sanded. The sanding can include any technique known to remove material, including, but not limited to, mechanical abrasion, laser etching, or chemical etching.

At 314 a release coating or the second coating 40 is applied to at least a portion of the vitreous or glassy carbon layer defining the first surface 48 of the first coating 30. The second coating 40 can be a neat resin or neat resin mixture, where the neat resin mixture can have a neat resin to acetone mass ratio is less than the neat resin mixture of the first coating 30. That is, the second coating 40 can be a neat resin mixture with a neat resin to acetone volume ratio of approximately 2:1, however, any resin to acetone ratio equal to or between 1:1 and 4:1 is contemplated.

While illustrated as a neat resin or a neat resin mixture, the second coating 40 can include the filler particles 50. The second coating 40 can be the same neat resin or use the same neat resin in the mixture for the first coating 30.

At 316, the second coating 40 is cured in the low temperate furnace operating at or between 80° C. and 250° C. However, it is contemplated that the second coating 40 is cured in the low temperate furnace operating at or between 100° C. and 200° C.

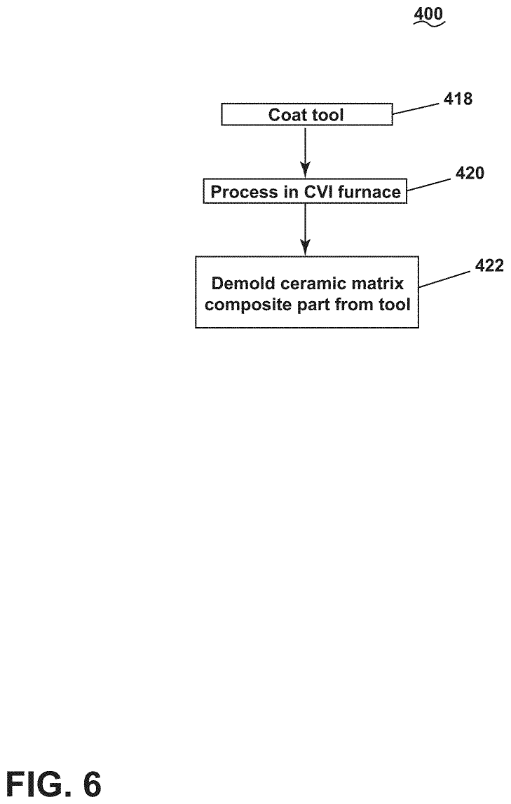

FIG. 6 illustrates a method 400 of using a tool for manufacturing a ceramic matrix composite part. At 418, the coating is disposed on the tool 14, 16. The tool 14, 16 includes the graphite body 28 having the multiple gas access holes 42 and the porous surface 44. The glassy carbon layer of the first coating 30 on the porous surface 44 hermetically seals the porous surface 44. The second coating 40 can be applied to the glassy carbon layer of the first coating 30.

At 420, the ceramic matrix composite part 12 as a fibrous preform is mounted, secured within, or assembled with the tool assembly 10. The tool assembly 10 and the ceramic matrix composite part 12 can be processed in the CVI furnace. The CVI process includes heating the CVI furnace at or between 900° C.-1700° C. while exposing the tool assembly 10 and the ceramic matrix composite part 12 to a gaseous species. For purposes of illustration, the gaseous species can be Silicon Carbide (SiC), however other CVI gasses and processes are contemplated. For example, the CVI process can be, but is not limited to, any one or more of carbon (C), silicon nitride (Si₃N₄), boron nitride (BN), boron carbide (B₄C), or zirconium carbide (ZrC) infiltration.

At 422, the ceramic matrix composite part 12, now the combination of the fibrous preform and the material or materials deposited by the CVI process, can be demolded. That is, the ceramic matrix composite part is removed from the tool 14, 16 or tool assembly 10.

Optionally, another ceramic matrix composite part in the form of a fibrous preform can be assembled or secured in the tool assembly 10. One benefit of the coating disposed on the tool assembly 10 in 418 is that several CVI processes on multiple ceramic matrix composite parts in the form of fibrous preforms can be complete before additional coatings or providing touch-ups to existing coatings.

Additional benefits associated with the disclosure as described herein include improvement to the coating of tools used in chemical vapor infiltration processes. The first coating and optional second coating, as described herein, provide a tool coating that is significantly smoother than the traditional process with the seal coating that requires CVI and the additional associated release coating.

The cost of the first coating, as described herein, is significantly less than the traditional CVI-based seal coating. The traditional CVI-based seal coating often adds at least one-third to the overall component cost and adds an additional 1-2 weeks to apply it.

The first coating, as described herein, only requires a low temperature furnace to cure at or between 60° C. and 250° C. (or between 80° C. and 200° C.) to seal the tool. This allows higher part throughput in the CVI furnace instead of it being partially used to seal tools.

The first coating, as opposed to the traditional seal coating, can save energy and provide an additional cost benefit. The first coating, as described herein, only requires a low temperature furnace operating at or between 60° C. and 250° C. (or between 80° C. and 200° C.) to seal the tool, as opposed to the traditional seal coating that require a CVI furnace operating at temperatures that can be between approximately 900° C. and 1700° C.

The first coating (one-step coating) or the first and second coating (two-step coating) is a faster way to coat CVI tools. For example, the first coating or the first and second coating can take approximately 3 days before the tool is ready for assembly. The traditional seal coating takes 6-8 days and the traditional seal coating with release coating or phenolic resin coating takes 9 days or more before the tool is ready for assembly.

Another benefit can be a decrease in required personal protective gear, as the first coating and second coating described herein can be furan-based resins as opposed to the phenolic resin used in the traditional release coating. For example, when using the furan-based resins, a full-face respirator is not required as is required when applying a phenolic resin.

Yet another benefit to the first coating or the first and second coating is that no additional coatings were required by the tool between multiple demolding of parts. The CVI-based coating requires the phenolic resin layer to be re-applied between preform rigidization cycles.

Another benefit of the coatings described in this disclosure is that they release the preform from the tool with less tool coating remnants adhering to the preform than the traditional coating. The traditional coating often requires an additional step in the manufacturing process of the component in which coating remnants adhering to the preform are fully removed. The coatings described in this disclosure can eliminate that step from the manufacturing process.

To the extent not already described, the different features and structures of the various aspects can be used in combination, or in substitution with each other as desired. That one feature is not illustrated in all of the examples is not meant to be construed that it cannot be so illustrated, but is done for brevity of description. Thus, the various features of the different aspects can be mixed and matched as desired to form new aspects, whether or not the new aspects are expressly described. All combinations or permutations of features described herein are covered by this disclosure.

This written description uses examples to describe aspects of the disclosure described herein, including the best mode, and also to enable any person skilled in the art to practice aspects of the disclosure, including making and using any devices or systems and performing any incorporated methods. The patentable scope of aspects of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

Further aspects of the disclosure are provided by the subject matter of the following clauses:

A tool for manufacturing a ceramic matrix composite part, the tool comprising a graphite body having multiple gas access holes and a porous surface for supporting the ceramic matrix composite part, and a glassy carbon layer on the porous surface that hermetically seals the porous surface.

The tool of the preceding clause, wherein the glassy carbon layer is formed by a heat-cured, carbon-yielding resin.

The tool of any preceding clause, wherein the carbon-yielding resin includes filler particles.

The tool of any preceding clause, wherein the carbon-yielding resin and the filler particles are non-reactive to one or more of silicon carbide (SiC), carbon (C), silicon nitride (Si3N4), boron nitride (BN), boron carbide (B4C), or zirconium carbide (ZrC) gasses.

The tool of any preceding clause, wherein the filler particles comprise graphite flakes.

The tool of any preceding clause, wherein the filler particles comprise at least one of a graphite, carbon, nitride, or carbide flake or powder.

The tool of any preceding clause, wherein a volume ratio of the carbon-yielding resin to the filler particles is equal to or between 2.5:1 to 7:1.

The tool of any preceding clause, further comprising a second coating on the glassy carbon layer, wherein the glassy carbon layer is part of a first coating located between the porous surface and the second coating.

The tool of any preceding clause, wherein the first coating comprises a thermosetting furan-based resin having the filler particles and the second coating comprises a neat resin or a neat resin mixture.

The tool of any preceding clause, wherein the first coating comprises multiple layers of the heat-cured, carbon-yielding resin.

The tool of any preceding clause, wherein the carbon-yielding resin is a thermosetting furan-based resin or resin having a char yield in excess of 30 percent by weight.

The tool of any of the preceding clauses, wherein the filler particles have a sulfur (S) content less than or equal to 0.1% of the total mass of the first coating.

The tool of any of the preceding clauses, wherein the carbon-yielding resin at least partially impregnates the porous surface.

A method of forming a tool for use in making a composite part in a chemical vapor infiltration process, the method comprising applying a first coating of carbon-yielding resin onto a porous surface of a graphite body for the tool, curing of the first coating of carbon-yielding resin with heat at a temperature equal to or between 80 degrees Celsius and 200 degrees Celsius, and pyrolyzing the first coating of carbon-yielding resin to create a vitreous or glassy carbon layer.

The method of any of the preceding clauses, further comprising, after the pyrolyzing, applying a second coating of carbon-yielding resin onto the first coating and then conducting a second curing of the second coating.

The method of any of the preceding clauses, wherein the first coating is a resin containing filler particles and the second coating is a neat resin or neat resin mixture.

The method of any of the preceding clauses, further comprising, after the pyrolyzing, sanding the vitreous or glassy carbon layer and applying a second coating of carbon-yielding resin onto the first coating and then conducting a second curing of the second coating.

The method of any of the preceding clauses, wherein the first coating of carbon-yielding resin contains filler particles.

The method of any of the preceding clauses, wherein the first coating of carbon-yielding resin at least partially impregnates pores of the graphite body.

The method of any of the preceding clauses, wherein the first coating and the second coating are a mixture of a neat resin and one or more solvents.

The method of any of the preceding clauses, wherein the filler particles are non-reactive to reactive to one or more of silicon carbide (SiC), carbon (C), silicon nitride (Si3N4), boron nitride (BN), boron carbide (B4C), or zirconium carbide (ZrC) gasses.

A method of using a tool for manufacturing a ceramic matrix composite part, the method comprising disposing a coating on the tool, wherein the tool comprises a graphite body having multiple gas access holes and a porous surface for supporting the ceramic matrix composite part, and the coating includes a glassy carbon layer on the porous surface that hermetically seals the porous surface, and processing the tool and the ceramic matrix composite part in a chemical vapor infiltration furnace.

The method of any of the preceding clauses, wherein the disposing of the coating includes a first coating having the glassy carbon layer and a second coating applied to the glassy carbon layer of the first coating.

The method of any of the preceding clauses, further comprising demolding the ceramic matrix composite part from the tool.

What is claimed is:

1. A tool for manufacturing a ceramic matrix composite part, the tool comprising:
a graphite body having multiple gas access holes and a porous surface for supporting the ceramic matrix composite part; and
a glassy carbon layer on the porous surface that hermetically seals the porous surface.

2. The tool of claim 1, wherein the glassy carbon layer is formed by a heat-cured, carbon-yielding resin.

3. The tool of claim 2, wherein the carbon-yielding resin includes filler particles.

4. The tool of claim 3, wherein the carbon-yielding resin and the filler particles are non-reactive to one or more of silicon carbide (SiC), carbon (C), silicon nitride (Si₃N₄), boron nitride (BN), boron carbide (B₄C), or zirconium carbide (ZrC) gasses.

5. The tool of claim 3, wherein the filler particles comprise graphite flakes.

6. The tool of claim 3, wherein the filler particles comprise at least one of a graphite, carbon, nitride, or carbide flake or powder.

7. The tool of claim 3, wherein a volume ratio of the carbon-yielding resin to the filler particles is equal to or between 2.5:1 to 7:1.

8. The tool of claim 3, further comprising a second coating on the glassy carbon layer, wherein the glassy carbon layer is part of a first coating located between the porous surface and the second coating.

9. The tool of claim 8, wherein the first coating comprises a thermosetting furan-based resin having the filler particles and the second coating comprises a neat resin or a neat resin mixture.

10. The tool of claim 8, wherein the first coating comprises multiple layers of the heat-cured, carbon-yielding resin.

11. The tool of claim 2, wherein the carbon-yielding resin is a thermosetting furan-based resin or resin having a char yield in excess of 30 percent by weight.

12. A method of forming a tool for use in making a composite part in a chemical vapor infiltration process, the method comprising:
applying a first coating of carbon-yielding resin onto a porous surface of a graphite body for the tool;
curing of the first coating of carbon-yielding resin with heat at a temperature equal to or between 80 degrees Celsius and 200 degrees Celsius; and
pyrolyzing the first coating of carbon-yielding resin to create a vitreous or glassy carbon layer.

13. The method of claim 12, further comprising, after the pyrolyzing, applying a second coating of carbon-yielding resin onto the first coating and then conducting a second curing of the second coating.

14. The method of claim 13, wherein the first coating is a resin containing filler particles and the second coating is a neat resin or neat resin mixture.

15. The method of claim 12, further comprising, after the pyrolyzing, sanding the vitreous or glassy carbon layer and applying a second coating of carbon-yielding resin onto the sanded vitreous or glassy carbon layer of the first coating and then conducting a second curing of the second coating.

16. The method of claim 12, wherein the first coating of carbon-yielding resin contains filler particles.

17. The method of claim 12, wherein the first coating of carbon-yielding resin at least partially impregnates pores of the graphite body.

18. A method of using a tool for manufacturing a ceramic matrix composite part, the method comprising:
disposing a coating on the tool, wherein the tool comprises a graphite body having multiple gas access holes and a porous surface for supporting the ceramic matrix composite part, and the coating includes a glassy carbon layer on the porous surface that hermetically seals the porous surface; and
processing the tool and the ceramic matrix composite part in a chemical vapor infiltration furnace.

19. The method of claim 18, wherein the disposing of the coating includes a first coating having the glassy carbon layer and a second coating applied to the glassy carbon layer of the first coating.

20. The method of claim 18, further comprising demolding the ceramic matrix composite part from the tool.
